(19) United States
(12) Patent Application Publication
(10) Pub. No.: US 2019/0210649 A1
(43) Pub. Date: Jul. 11, 2019

(54) Control Unit and a Method for Adapting a Steer-By-Wire System for an Automobile Driver

(71) Applicants: Robert Bosch GmbH, Stuttgart (DE); Robert Bosch Engineering and Business Solutions Private Limited, Bangalore (IN)

(72) Inventors: Hamilton Victor Sahaya, Kanyakumari (IN); Nikhil Mohan Mangalasseri, Wayanad (IN)

(21) Appl. No.: 15/864,263

(22) Filed: Jan. 8, 2018

(51) Int. Cl. B62D 15/02; B62D 5/04; B62D 6/00

(52) U.S. Cl. CPC B62D 15/025; B62D 6/008; B62D 15/021; B62D 5/0457

(57) ABSTRACT

A method (20) and a control unit (10) for adapting a steer-by-wire system for a driver in an automobile is disclosed. Firstly, signals are acquired from a set of sensors comprising at least one of a vehicle speed sensor, a vehicle acceleration sensor, a steering angle sensor, a steering torque sensor and a yaw rate sensor. The signals from the sensors are processed to determine whether the driver is a trained driver or an untrained driver. Secondly, signals are acquired from the set of sensors comprising at least a vehicle acceleration sensor, a steering angle sensor, a steering torque sensor. The signals are then processed using fuzzy logic to determine whether the driver is a low sensitivity driver or a high sensitivity driver. The technical advantage of the above processing is that a steering ratio is applied to the steer-by-wire system to reduce driver fatigue and improve ease of driving.

### TECHNICAL FIELD

This disclosure relates to a control unit and a method for adapting a steer-by-wire system for a driver in an automobile.

### BACKGROUND

One of the many components in an automobile is a steering system and the importance of the steering system cannot be overstated. The steering system helps the driver of the vehicle or automobile to keep the vehicle in a steady path and direction and also to take turns whenever needed. Accidents or mishaps do happen sometimes because the driver of the vehicle is not able to steer the vehicle properly into the desired direction, apart from the many other reasons leading to accidents.

### SUMMARY

A method of adapting a steer-by-wire system for a driver in an automobile is disclosed. The method comprises: acquiring signals from a first set of sensors in the automobile over a predefined period of time, by a control unit; processing the signals acquired from the first set of sensors, by the control unit, to determine whether the driver is any one of a trained driver and an untrained driver; acquiring signals from a second set of sensors over another predefined period of time, by the control unit; processing the signals acquired from the second set of sensors over another predefined period of time, by the control unit, to determine whether the driver is any one of a low sensitivity driver and a high sensitivity driver; and applying a steering ratio to the steer-by-wire system, by the control unit, based on whether the driver is any one of the trained driver and the untrained driver and any one of the low sensitivity driver and the high sensitivity driver.

### BRIEF DESCRIPTION OF DRAWINGS

Embodiments of this disclosure is explained in principle below with reference to the drawings. The drawings are:

FIG. 1 illustrates a schematic of a first arrangement involving a control unit connected to a plurality of sensors;

FIG. 2 illustrates a schematic of a second arrangement involving the control unit connected to an electronic network;

FIG. 3 illustrates steps in a method of adapting a steer-by-wire system for the driver in the automobile;

FIG. 4a illustrates fuzzy logic membership functions for changes in acceleration;

FIG. 4b illustrates fuzzy logic membership functions for changes in steering angle;

FIG. 4c illustrates fuzzy logic membership functions for changes in steering torque; and

FIG. 4d illustrates fuzzy logic membership functions for steering correction rate.

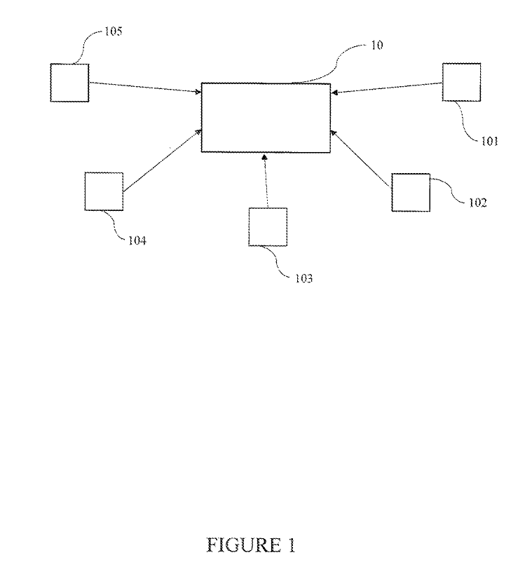

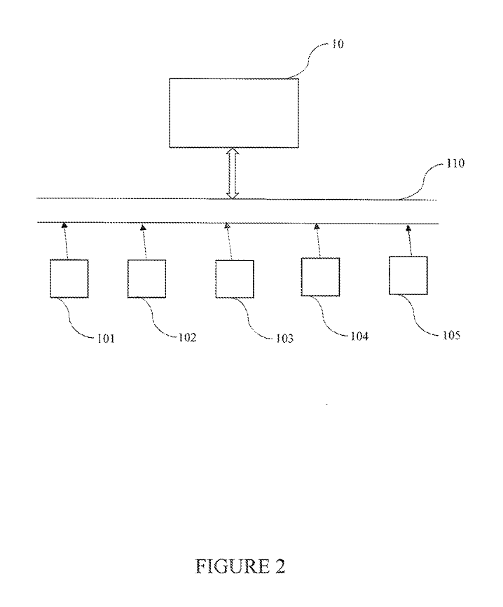

FIG. 1 illustrates a schematic of a first arrangement involving a control unit 10 connected to a plurality of sensors (101, 102, 103, 104 and 105). In this arrangement, the control unit 10 receives signals directly from the plurality of sensors (101, 102, 103, 104 and 105). In the context of the above sentence, directly refers to reception of the signals from the plurality of sensors by the control unit 10 without any interference or involvement of any other or external hardware entity. In other words, the only hardware entities involved are the control unit 10 and the plurality of sensors (101, 102, 103, 104 and 105). FIG. 2 illustrates a schematic of a second arrangement involving the control unit 10 connected to an electronic network 110. The electronic network 110 can be a controller area network (CAN) or any similar network commonly installed in automobiles and networks. In the second arrangement, the electronic network 110 receives the signals from the plurality of sensors (101, 102, 103, 104 and 105) and the control unit 10 receives the signals from the electronic network 110. The control unit 10 can be any electronic control unit or a microprocessor used in automobiles to acquire and process information generated in the automobile and control the functions of the automobile. An example of the control unit 10 can be an ECU or an electronic control unit, that is commonly installed and used in automobiles. Information exchange to and from the electronic network 110 is understood by a person of ordinary skill in the art. The plurality of sensors (101, 102, 103, 104 and 105) in the first arrangement and the second arrangement mentioned above and in the context of this instant applicant is not limited to five. Five is just an example and the plurality of sensors can take on any number. The plurality of sensors will be described hereinafter.

The control unit 10 for adapting a steer-by-wire system for a driver in the automobile is adapted to acquire signals from a first set of sensors over a predefined period of time. The control unit 10 is further adapted to process the signals acquired from the first set of sensors to determine whether the driver is anyone of a trained driver and an untrained driver. The control unit 10 is further adapted to acquire signals from a second set of sensors over another predefined period of time. After the acquisition, the control unit 10 is further adapted to process the signals acquired from the second set of sensors over another predefined period of time to determine whether the driver is anyone of a low sensitivity driver and a high sensitivity driver. The control unit 10 is further adapted to apply a steering ratio to the steer-by-wire system based on whether the driver is anyone of the trained driver or the untrained driver and anyone of the low sensitivity driver and the high sensitivity driver. The steer-by-wire system, which is understood by the person having ordinary skill in the art, is a steering system that has a combination of both mechanical and electronic controls. In other words, many mechanical components of conventional steering systems are replaced with electronic components in the steer-by-wire system.

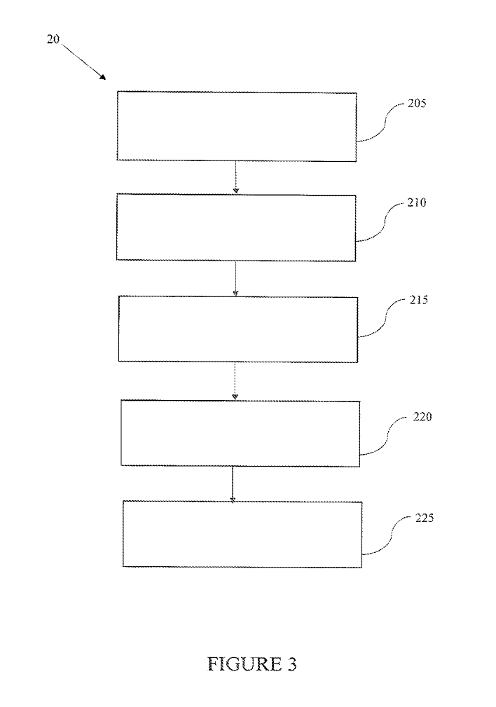

FIG. 3 illustrates steps in a method 20 of adapting the steer-by-wire system for the driver in an automobile. The method 20 comprises a first step 205 of acquiring signals from a first set of sensors in the automobile over a predefined period of time, by a control unit 10. The method 20 comprises a second step 210 of processing the signals acquired from the first set of sensors, by the control unit 10, to determine whether the driver is anyone of a trained driver and an untrained driver. The method 20 comprises a third step 215 of acquiring signals from a second set of sensors over another predefined period of time by the control unit 10. The method 20 comprises a fourth step 220 of processing the signals acquired from the second set of sensors over another predefined period of time, by the control unit 10, to determine whether the driver is anyone of a low sensitivity driver and a high sensitivity driver. The method 20 comprises a fifth step 225 of applying a steering ratio to the steer-by-wire system by the control unit 10, based on whether the driver is anyone of the trained driver and the untrained driver and anyone of the low sensitivity driver and the high sensitivity driver.

The first set of sensors comprise at least one of a vehicle speed sensor, a vehicle acceleration sensor, a steering angle sensor, a steering torque sensor and a yaw rate sensor. The sensors mentioned above form the plurality of sensors described earlier. As the name implies, the vehicle speed sensor measures the speed of the vehicle, the vehicle acceleration sensor measures the vehicle's acceleration, the steering angle sensor measures the angle of turning of the steering, the steering torque sensor measures the torque applied to the steering wheel and the yaw rate sensor measures the yaw rate of the vehicle. The yaw rate is the vehicle's angular velocity around a vertical axis of the vehicle. The first set of sensors can be one sensor or more from the plurality of sensors mentioned above. The second set of sensors comprise at least one of the vehicle speed sensor, the vehicle acceleration sensor, the steering angle sensor, the steering torque sensor and the yaw rate sensor. The second set of sensors can be one sensor or more from the plurality of sensors mentioned above.

In the method 20, acquiring signals from the first set of sensors by the control unit 10 comprises receiving signals directly from the first set of sensors. Receiving signals directly has already been described earlier in the instant specification. In the method 20, alternatively, acquiring signals from the first set of sensors by the control unit 10 comprises receiving signals through the electronic network 110 in the vehicle or automobile. In the method 20, acquiring signals from the second set of sensors by the control unit 10 comprises receiving signals directly from the second set of sensors. In the method 20, alternatively, acquiring signals from the second set of sensors by the control unit 10 comprises receiving signals through the electronic network 110 in the vehicle or automobile.

In the method 20, the processing of signals acquired from the second set of sensors over another predefined period of time by the control unit 10, to determine whether the driver is anyone of the low driver sensitivity region and the high driver sensitivity region comprises processing the signals acquired from the second set of sensors with fuzzy logic.

Set, in the context of this application, can comprise any numerical value, i.e., from one to any value more than one. As an example, the set can comprise just one value. As another example, the set can comprise 2 values. As yet another example, the set can comprise 5 values. As a further example, the set can comprise 10 values.

The working of the method 20 is described hereinafter. In the step 205, signals are acquired from the first set of sensors over the predefined period of time. The first set of sensors have already been described earlier. The first set of sensors can include only one sensor or more than one sensor from the plurality of sensors. As an example, the first set of sensors comprises a steering angle sensor only. Therefore, in the step 205, signals are acquired from the steering angle sensor for 5 seconds. The predefined period of time is not limited to 5 seconds only and can take on other values as well.

The signals acquired in step 205 is for processing in the step 210 to determine whether the driver is anyone of the trained driver and the untrained driver. As an example, the signals from the steering angle sensor is processed to check if they fall within a predefined threshold. For instance, when the driver is driving continuously in a linear stretch of a road or highway, a trained driver generally will not keep making corrections to the steering wheel continuously along the path, whereas an untrained driver generally may keep making corrections to the steering wheel. The same comparison holds good after the driver has taken a right turn or left turn or U-turn. The steering angle sensor measures the angle to which the steering wheel is rotated. The more the steering wheel is rotated, the higher the angle measured by the steering angle sensor. If the signals from the steering angle sensor acquired over the predefined period of time crosses the predefined threshold, then the driver is categorized as an untrained driver. If the signals from the steering angle sensor acquired over the predefined period of time falls within the predefined threshold, then the driver is categorized as a trained driver. For example, if the predefined threshold of the steering angle is 5°, and if the acquired signals correspond to steering angles less than 5°, then the driver is a trained driver. And if the acquired signals correspond to steering angles greater than 5°, then the driver is an untrained driver. However, in the predefined period of time, a plurality of signals individually are acquired from the steering angle sensor. Not all the signals in the plurality of signals may fall within or beyond the predefined threshold of any measurement from any of the plurality of sensors. To elaborate with the same example as above, for a trained driver driving along a linear path, a majority of the plurality of signals acquired will fall within the predefined threshold, but there is a possibility of a minority of the plurality of signals acquired to fall beyond the threshold limit, because the driver might negotiate a pothole and might just steer the vehicle sharply. Therefore, a predefined percentage limit for the plurality of signals acquired is configured and used during the processing in the step 210. This predefined percentage limit is to compensate for the outliers created in the acquired signals because of environmental conditions that are not under the control of the trained driver. This predefined percentage limit is only applied when the processing of the plurality of signals acquired indicate that the driver may be a trained driver. To elaborate, if not all the plurality of signals but the majority of the plurality of signals acquired fall within the threshold limit, the predefined percentage limit is applied to check if the majority is beyond the predefined percentage limit or not. If the majority falls beyond the threshold percentage limit, then the driver is a trained driver. For example, if the predefined percentage limit is 75% and if 8 signals points within 10 signals points fall within the predefined threshold for the steering angle sensor, then the driver is a trained driver as the 80% of the signals are within the predefined threshold and 80% is greater than the predefined percentage limit of 75%. If only 7 signal points are within the predefined threshold, then the driver will be categorized as an untrained driver. This processing is done in the control unit 10.

The above described is just an example and the processing in step 210 can be done with signals acquired from more than one sensor also.

In the step 215, the signals are acquired from the second set of sensors over another predefined period of time by the control unit 10. The second set of sensors can be the same as or different from the first set of sensors, in terms of the sensors selected from the plurality of sensors. For example, the first set of sensors can have two sensors, whereas the second set of sensors can have three sensors. To elaborate with an example, the second set of sensors can comprise the vehicle acceleration sensor, the steering angle sensor and the steering torque sensor. The another predefined period of time in step 215 can be the same as or different from the predefined period of time in step 205.

In the step 220, the signals acquired in the step 215 are processed by the control unit 10 to determine whether the driver is a low sensitive driver or a high sensitive driver. The low sensitive driver takes action relatively slower than the high sensitive driver. The high sensitive driver is quick to respond to situations. The low sensitive driver tends to oversteer and the high sensitive driver tends to understeer. Fuzzy logic is used for computations done in the processing step 220. Events and membership functions are used for computation of the sensitivity values using fuzzy logic algorithms. The processing in step 220 is described with an example below.

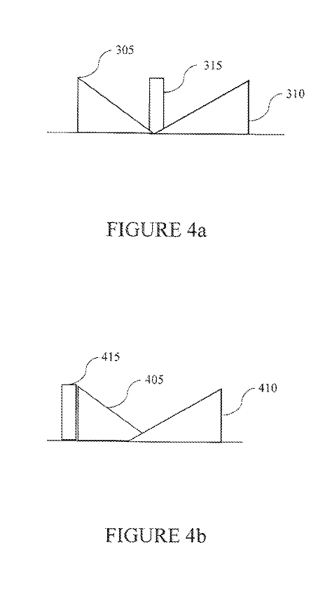

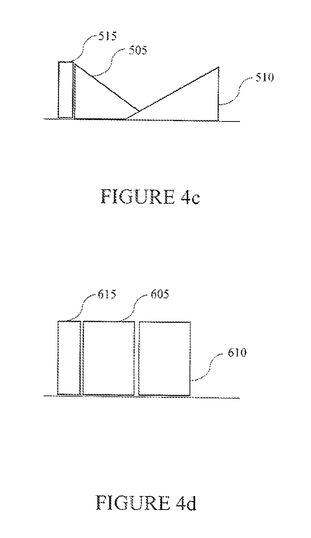

Membership functions for fuzzy logic are understood by the person of ordinary skill in the art. A membership function is a curve that defines how each point in an input space is mapped to a membership value between 0 and 1. FIG. 4a illustrates fuzzy logic membership functions for changes in acceleration. Small changes in acceleration are represented by a triangular section 305, large changes in acceleration are represented by a triangular section 310 and no changes or very small changes are represented by a rectangular section 315. An example for small changes in the acceleration can be −5 km/s² to +5 km/s². An example for no change or very small change in the acceleration can be −2 km/s² to +2 km/s² and an example for large changes in acceleration can be −20 km/s² to +20 km/s². FIG. 4b illustrates fuzzy logic membership functions for changes in steering angle. Small changes in steering angle are represented by a triangular section 405, large changes in acceleration are represented by a triangular section 410 and no changes or very small changes are represented by a rectangular section 415. An example for small changes in the steering angle can be 2.5 degrees to 10 degrees, an example for very small changes or no changes can be 0 to 2.5 degrees and an example for large changes can be 10 to 30 degrees.

FIG. 4c illustrates fuzzy logic membership functions for changes in steering torque. Small changes in steering torque are represented by a triangular section 505, large changes in steering torque are represented by a triangular section 510 and no changes or very small changes are represented by a rectangular section 515. An example for small changes can be 0.1 Nm to 1 Nm, an example for large changes can be 1 Nm to 3 Nm and an example for very small or no changes can be 0 to 0.1 Nm.

FIG. 4d illustrates fuzzy logic membership functions for steering correction rate. Small changes in steering correction rate are represented by a rectangular section 605, large changes in steering correction rate are represented by a rectangular section 610 and no changes or very small changes are represented by a rectangular section 615. The steering correction rate is obtained from changes in the steering torque. Any change in the steering torque is counted as a steering correction and the steering correction over a period of time is the steering correction rate. An example of small change in the steering correction rate is 0.1 Nm/s to 1 Nm/s, an example of large change in the steering correction rate is 1 Nm/s to 3 Nm/s and an example of very small change to no change is 0 to 0.1 Nm/s.

In this example, if the acquired signal from the vehicle acceleration sensor falls within a region bound by the rectangular section 315 (no changes or very small changes in acceleration), the acquired signal from the steering torque sensor falls within a region bound by the triangular section 505 (small changes in steering torque), the acquired signal from the steering angle sensor falls within a region bound by the rectangular section 415 (no changes or very small changes in steering angle) and the steer correction rate falls within a region bound by the rectangular section 605 (small changes in steering correction rate), then the driver sensitivity is low. And similarly, if the acquired signal from the vehicle acceleration sensor falls within a region bound by the rectangular section 315 (no change or very small changes in acceleration), the acquired signal from the steering torque sensor falls within a region bound by the triangular region 510 (large changes in steering torque), the acquired signal from the steering angle sensor falls within a region bound by the rectangular section 415 (no change or very small change in steering angle) and the steer correction rate falls within a region bound by the rectangular section 605 (small change in steering correction rate) or section 610 (large change in steering correction rate), then the driver sensitivity is high.

In the fifth step 225, the control unit 10 applies a steering ratio to the steer-by-wire system by selecting a particular steering ratio. Steering ratio refers to the ratio between the turn of the steering wheel and the turn of the wheels in degrees. A higher steering ratio means that the steering wheel has to be turned more to get the wheels turning, whereas a low steering ratio means that the steering wheel has to be turned less to get the wheel turning. The control unit 10 stores a plurality of steering ratios and an appropriate ratio is selected and applied to the steer-by-wire system. This changes the angle that the driver needs to turn the steering wheel to execute a required turn of the wheels of the vehicles. A range of higher steering ratios applied can range from 11:1 to 20:1, which is for trained drivers. A range of lower steering ratios applied can range from 3:1 to 10:1, which is for untrained drivers. Generally, untrained or inexperienced drivers tend to correct the course or their steering directions frequently and hence, applying lower steering ratios will be of help and advantageous in this case. This is because little turns of the steering angle can bring the required course correction. On the other hand, as trained drivers are relatively unlikely to course correct frequently, higher steering angles are applicable to trained drivers. Each of the steering ratio ranges, higher and lower can be divided into high sensitivity range and low sensitivity range. To elaborate, the high sensitivity range of the higher steering ratio range is from 16:1 to 20:1 and the low sensitivity range of the higher steering ratio range is from 11:1 to 15:1. Similarly, the high sensitivity range of the lower steering ratio range is from 7:1 to 10:1 and the low sensitivity range of the lower steering ratio range is from 3:1 to 6:1. In general, high sensitivity drivers tend to react spontaneously or immediately to a change in any external stimulus and may also steer a little too more to any external change. Therefore, the above tendency of high sensitivity drivers can be offset or balanced by having a higher steering ratio. Therefore, the high sensitivity range in both the higher steering ratio range and the lower steering ratio range is applied to high sensitivity drivers. Similarly, the low sensitivity range in both the higher steering ratio range and the lower steering ratio range is applied to low sensitivity drivers. The above ranges are exemplary. In the industry, the same ranges or similar ranges can be applied.

Hence, for a trained driver who is a high sensitivity driver, a ratio from 16:1 to 20:1 is chosen. For a trained driver who is a low sensitivity driver, a ratio from 11:1 to 15:1 is chosen. For an untrained driver who is a high sensitivity driver, a ratio from 7:1 to 10:1 is chosen. For an untrained driver who is a low sensitivity driver, a ratio from 3:1 to 6:1 is chosen. Selection of a single ratio from a range is dependent on the model of the automobile, availability of the ratio etc.

The advantage of the above method and the adaptation of the control unit 10 is such that the steer-by-wire system is facilitated to adapt or change depending on the performance and skill level of the driver. This reduces driving fatigue for the driver and improves the ease with which a driver drives. These result in reduced accidents and mishaps.

It is to be understood that the foregoing description is intended to be purely illustrative of the principles of the disclosed techniques, rather than exhaustive thereof, and that changes and variations will be apparent to those skilled in the art, and that the present disclosure is not intended to be limited other than as expressly set forth in the following claims.

1. A method of adapting a steer-by-wire system for a driver in an automobile, the method comprising:
acquiring first signals from a first set of sensors in the automobile over a first predefined period of time, with a control unit;
processing the first signals acquired from the first set of sensors, with the control unit, to determine whether the driver is one of a trained driver and an untrained driver;
acquiring second signals from a second set of sensors over a second predefined period of time, with the control unit;
processing the second signals acquired from the second set of sensors, with the control unit, to determine whether the driver is one of a low sensitivity driver and a high sensitivity driver; and
applying a steering ratio to the steer-by-wire system, with the control unit, based on whether the driver is the one of the trained driver and the untrained driver and the one of the low sensitivity driver and the high sensitivity driver.

2. The method as claimed in claim 1, wherein the first set of sensors comprise at least one of a vehicle speed sensor, a vehicle acceleration sensor, a steering angle sensor, a steering torque sensor, and a yaw rate sensor.

3. The method as claimed in claim 1, wherein the second set of sensors comprise at least one of a vehicle speed sensor, a vehicle acceleration sensor, a steering angle sensor, a steering torque sensor, and a yaw rate sensor.

4. The method as claimed in claim 1, the acquiring of the first signals further comprising:
receiving the first signals directly from the first set of sensors.

5. The method as claimed in claim 1, the acquiring of the first signals further comprising:
receiving the first signals through an electronic network in the automobile.

6. The method as claimed in claim 1, the acquiring of the second further comprising:
receiving the second signals directly from the second set of sensors.

7. The method as claimed in claim 1, the acquiring of the second further comprising:
receiving the second signals through a electronic network in the automobile.

8. The method as claimed in claim 1, the processing of the second signals further comprising:
processing the second signals with fuzzy logic.

9. A control unit for adapting a steer-by-wire system for a driver in an automobile, the control unit configured to:
acquire first signals from a first set of sensors over a first predefined period of time;
process the first signals acquired from the first set of sensors to determine whether the driver is one of a trained driver and an untrained driver;
acquire second signals from a second set of sensors over a second predefined period of time;
process the second signals acquired from the second set of sensors to determine whether the driver is one of a low sensitivity driver and a high sensitivity driver; and
apply a steering ratio to the steer-by-wire system based on whether the driver is the one of the trained driver and the untrained driver and the one of the low sensitivity driver and the high sensitivity driver.
